(19) United States
(12) Patent Application Publication
(10) Pub. No.: US 2019/0279428 A1
(43) Pub. Date: Sep. 12, 2019

(54) TEAM AUGMENTED REALITY SYSTEM

(71) Applicant: LIGHTCRAFT TECHNOLOGY LLC, Culver City, CA (US)

(72) Inventors: Newton Eliot Mack, Culver City, CA (US); Philip R. Mass, Culver City, CA (US); Winston C. Tao, Culver City, CA (US)

(21) Appl. No.: 16/349,836

(22) PCT Filed: Apr. 17, 2017
(86) PCT No.: PCT/US17/28008

§ 371 Date: May 14, 2019

Related U.S. Application Data
(60) Provisional application No. 62/421,939, filed on Nov. 14, 2016.
(60) Provisional application No. 62/421,952, filed on Nov. 14, 2016.
(60) Provisional application No. 62/438,382, filed on Dec. 22, 2016.

(51) Int. Cl. G06T 19/00; G06T 7/90; G06F 3/01; H04N 9/75; H04N 9/64; A63F 13/25; A63F 13/212; A63F 13/213; A63F 13/211

(52) U.S. Cl. CPC G06T 19/006; G06T 7/90; G06F 3/012; H04N 9/75; H04N 9/646; A63F 2250/497; A63F 13/212; A63F 13/213; A63F 13/211; G06T 2219/024; A63F 13/25

(57) ABSTRACT

A system for combining live action and virtual images in real time into a final composite image as viewed by a user through a head mounted display, and which uses a self-contained tracking sensor to enable large groups of users to use the system simultaneously and in complex walled environments, and a color keying based algorithm to determine display of real or virtual imagery to the user.

### CROSS-REFERENCE TO RELATED APPLICATIONS

This application claims the filing date benefit of copending U.S. provisional application No. 62/438,382, filed Dec. 22, 2016, of copending U.S. provisional application No. 62/421,952 (952), filed Nov. 14, 2016, of copending U.S. provisional application No. 62/421,939 (939), filed Nov. 14, 2016, of International Application No. PCT/US17/27960, filed Apr. 17, 2017, which claims the filing date benefit of the '939 application, and of International Application No. PCT/US17/27993, filed Apr. 17, 2017, which claims the filing date benefit of the '952 application. The entire contents of all of these applications are hereby incorporated by reference.

### BACKGROUND

The present disclosure relates generally to the technology of combining real scene elements and virtual elements into a final composite image as viewed by a user through a head mounted display. More specifically, the disclosure relates to methods for making this possible for large numbers of simultaneous users without encountering scaling problems.

The state of the art in combining live action imagery with imagery from a real time 3D engine into a synthetic image that is viewed by a user through a head mounted display is a process that requires considerable speed, precision and robustness. This method is typically called augmented reality, or AR. Virtual reality, or VR, typically describes completely replacing the real world environment with a synthetic virtual environment. Methods for doing both AR and VR for multiple simultaneous users in a single space have been attempted for many years, but the various technologies involved had similar problems that prevented this useful and powerful method from being widely adopted in the entertainment, military, business and simulation industries.

### SUMMARY

There are several different areas of technology that have to work well for the finished composite image to be seamless, and avoid causing motion sickness in the user, including rapid and accurate motion tracking of the user's head and hand controllers, and seamlessly combining live action and virtual imagery.

First, the motions of the user's head must be tracked accurately and with low latency. Recent developments in virtual and augmented reality have made great strides in this area, but they typically have limitations that prevent multiple users in the same space. For example, the HTC Corporation of Taipei, Taiwan, created the Vive virtual reality system that performs accurate head and hand controller tracking over a 5 m×5 m range. However, since the tracking is achieved by sideways mounted beacons that require a direct line of sight to the user's head mounted display (HMD) and hand controllers, larger numbers of users (more than two or three) cannot operate in the same space at the same time. This type of limitation is shared by most consumer space VR type systems.

An alternative motion capture based method has been used by many groups attempting to have multiple simultaneous players. In this case, a traditional motion capture system, such as the OptiTrack by NaturalPoint Corporation of Corvallis, Oreg., is set up in the space, and the locations of the individual users and their hand controllers or weapons are tracked with traditional reflective motion capture markers. When a marker can be seen by two or more of the motion capture cameras, its location can be calculated. However, this again means that a clear line of sight is required between multiple overlapping cameras and the markers, requiring that the users walk around in either an open space, or one where any walls have been shortened to approximately waist height, in order to make this line of sight possible. These motion capture systems also have an inherent scaling problem, which is that a fixed number of cameras must attempt to recognize all of the users in the space, and the motion solving algorithms rapidly become confused and break down when large numbers of people are being tracked at once. This is a recurring problem in many installations using this type of technology.

Another method of tracking exists where a camera in the user's headset looks out at the environment, and recognizes naturally occurring features in order to track the motion of the user's head. This technology is used by Google's Tango project, as well as many self-driving car technologies. However, this technology requires a high density of visible ‘corner features’ (visible corners or rough textures) in order to track accurately, and in many cases (such as the use of blue or green solid hued walls), there are very few naturally-occurring visible features, which makes this type of tracker unstable in even-hued environments. This approach also encounters problems when many users are grouped closely together, for example in military training simulations where a squad is within a couple feet of each other. In these situations, the tracking cameras (which are typically side-facing to best see environmental features) can rapidly become confused by the close presence of other users who are moving.

Seamlessly combining live action and synthetic imagery is a goal pursued by many groups. The Hololens system made by Microsoft Corporation of Redmond, Wash., is one example. It uses a partially reflective visor in front of the user's eyes to project virtual imagery onto. This method is common for augmented reality systems. However, this method has a number of problems. For example, there is no way to ‘remove’ light from the outside world; a virtual pixel must always be brighter than the real world lighting it is displayed over, or it will simply not show up. Many methods have attempted to solve this by selectively darkening one portion of the visor or another, but these methods typically do not work on a per-pixel basis as the focal distance of the user's eye is not the distance to the visor, so the darkened area of the visor is blurry instead of sharp.

Other attempts at providing a blend of synthetic and live action imagery have used a video camera mounted in front of each eye on the user's HMD, which then feed the live action image back through to the user's eye displays. This method has typically not worked well, as the latency between when the cameras capture an image and when the image is displayed on the user's eye displays is high enough that the lag rapidly induces motion sickness in the user. With increasing camera frame rates and transfer speeds, however, this method is becoming more workable. The Totem HMD manufactured by VRVana of Montreal, Canada, has dedicated FPGA circuitry to transfer the live action image to the user's eye displays, resulting in a very low-latency image that can still be combined with virtual imagery.

All of these methods have a common problem in that it is difficult to generate a virtual environment with the tactile feedback of a real environment. If a game or simulation has a virtual wall, without a physical object there the player is free to walk through the wall, destroying the illusion. However, building a physical wall with the exact desired look is typically too expensive. This problem is solved in the television and visual effects world by the use of a blue or green painted object. Computer vision algorithms used in the post production stage can then find and remove the blue or green portions of the image, and replace those image portions with virtual imagery. This process is typically called keying in the visual effects industry.

These keying algorithms, however, are typically computationally expensive and do not run in real time. There are a few real time algorithms, but they are typically very sensitive to the evenness of lighting on the blue or green surface, which is problematic in situations where the blue or green walls or objects are close enough to touch, as in an AR simulation. For smaller, complex objects that will be touched directly by the user, however, it becomes easier to place an actual physical object of the desired look and feel in the scene, as long as the user has a way of simultaneously seeing both the physical object and the virtual world. For example, making a virtual stairway, guardrail or door handle is problematic, as the user needs to be very confident as to what they are stepping or holding onto for safety reasons. It would be useful to selectively mix and match the visibility of physical and virtual objects to best fit the current needs of the simulation.

Since most group activities are done either for fun or for training, it would be useful is to be able to capture the actions of the group as seen from a third person spectator point of view, but integrated into the virtual environment so that the spectator can see what the users are encountering and reacting against. This is typically termed mixed reality, but at present no mixed reality solutions exist for groups or teams working simultaneously.

Finally, it is difficult to accurately align the live action and virtual worlds when assembling the physical components of a simulation. Measuring accurately over a large space, such as a warehouse, becomes inaccurate with manual methods, and trying to align physical structures with virtual coordinates by eye is time consuming. It would be ideal to be able to use physical objects that are directly viewable by the user for precise manipulation, such as door handles, while optionally replacing pieces of the environment virtually with CGI images, such as large background landscapes or buildings that would be prohibitive to build physically.

Provided herein is a real time method for combining live action and rendered 3D imagery for multiple users wearing head mounted displays that can scale to very large numbers of simultaneous users (hundreds) in large spaces (such as warehouses), without encountering tracking performance or scaling problems. The technology also allows users to operate very close to each other, such as is typical in a military simulation or a combat game, without encountering tracking or occlusion problems. The tracking, keying and rendering for a given user is self-contained to equipment carried by the user, so that problems with an individual user's equipment do not cause a systemwide problem.

A system herein can provide a rapid method or keying algorithm to clearly separate live action and virtual objects, including combining live action and virtual in a single object. The system can track accurately when the users are surrounded by high walls that extend over their heads, so that they cannot see other users or players behind the wall, creating a realistic simulation scenario. The system can also reliably and accurately track the user's position even when the surrounding walls and environment are painted a solid shade of blue or green for keying purposes.

A system herein can provide a simple way to make physical objects easily replaceable by virtual counterparts, such as painting a physical wall or prop blue or green, and having the system replace the blue or green wall or prop with a virtual textured wall to provide the user with a sense of presence in the virtual space when they lean against a wall or object.

A system herein can provide a keying algorithm that can operate with very low latency, and handle a wide variety of lighting variations on the blue or green environment. The users can readily see their friends' and opponents' actual bodies and movements, but enveloped in a virtual environment to provide a sense of immersion, making it easy to do collaborative group activities such as military squad training, industrial collaboration or group gaming.

A system herein can automatically map the lighting and texture variations found in the 3D physical environment, to assist in the keying process. The system can accurately calculate where the user's hands were when they touched a surface, making it possible to have virtual buttons and switches.

A system herein can enable a third person spectator viewpoint of the group in action, with the live action players viewed in correct relationship with the virtual is environment that they are experiencing. The moving obstacles and objects in the environment can be tracked individually and replaced visually with virtual imagery. Along the same lines, the player's hand controller or ‘gun’ can be visually replaced in real time with whatever artistically rendered object is correct for the simulation.

A system herein can make it straightforward to align real world items such as walls and objects with the pre-created virtual world, so that construction of the physical model can happen quickly and without confusion.

Various embodiments of a team augmented reality (team AR) system and corresponding methods are provided in the present disclosure. In one embodiment, a team AR system includes a head mounted display (HMD) worn by a user. This HMD has at least one front-facing camera that can be connected to the HMD's eye displays via a low-latency connection. The HMD can be mounted to a self-contained tracking system with an upward-facing tracking camera. The self-contained tracking system can include a camera, a lens, an inertial measurement unit (IMU), and an embedded computer. On the ceiling over the player, fiducial tracking targets can be mounted so that they can be seen by the upward-facing tracking camera. The user can carry one or more hand controllers. These hand controllers can also have a self-contained tracker with an upward-facing tracking camera. The user can wear a portable computer that is connected to the HMD and the self-contained trackers with a data connection. This connection can be a wired or wireless link.

The users can walk through a large space below the tracking fiducial targets. This space can have multiple walls in it to create a physical simulation of the desired player environment. These walls can be painted a solid blue or green color, or painted in other ways to resemble physical locations. The places on the wall that are painted blue or green will disappear to the user, and be replaced by virtual imagery generated by the portable computer worn by the user. The position and orientation of the virtual imagery are provided by the self-contained tracker mounted on the HMD. In addition, the position of the hand controller is also tracked and measured, so that the user can aim in the simulation. This information is directed into a real-time 3D engine running in the portable computer. This 3D engine can be the Unreal Engine made by Epic Games of Cary, N.C.

Since the 3D engine is already designed for network usage, the positions of each player and their hand controllers is updated in real time to all the other users in the same space, over a standard wireless network connection. In this way, the same 3D engine technology used to handle hundreds of simultaneous users in a networked video game can be used to handle hundreds of simultaneous users in a single environment.

The low latency pass-through system can contain a high-speed keying algorithm such as a color difference keying algorithm, the details of which are well understood to practitioners in the art. Through the use of the keying algorithm, the visual appearance of any physical object can be replaced with a virtual version of that object.

The HMD can contain depth calculation hardware that can determine the distance from the user of real world elements seen through the headset. Through the combination of the overall self-contained tracker mounted to the HMD, and the depth sensor on the HMD, it is possible to determine the 3D location of various physical objects, such as corners and walls, as well as the color and lighting level of the surfaces that the user is presently looking at. This can be used to build up a 3D map of lighting variations, which can be used in conjunction with the keying system to provide high quality real time keying that is resistant to lighting variations, similar to U.S. Pat. No. 7,999,862.

In addition, the combination of a depth sensor linked to a 3D self-contained tracker means that when a user reaches out and presses a virtual button in his field of view, it is possible to determine when his finger intersects with a 3D surface at a given 3D location. This provides the ability to create virtual control panels in the world, so the user can interact with virtual equipment. In addition, audio or tactile feedback (in the absense of a physical prop) can be incorporated, so that the users know that they have pressed the virtual control. This provides considerable support for training and assembly type simulations.

Disclosed herein is a system which includes: a helmet mounted display (HMD) for a user; a front-facing camera or cameras; and a low latency (e.g., 25 milliseconds) keying module configured to mix virtual and live action environments and objects in an augmented reality game or simulation. The keying module can be configured to composite the live action image from the front facing camera with a rendered virtual image from the point of view of the HMD, and send the composited image to the HMD so the user can see the combined image. The keying module can be configured to take in a live action image from the camera, and perform a color difference and despill operation on the image to determine how to mix it with an image of a virtual environment. The sensor can be configured to determine a position of the user in a physical space, and the keying module can be configured to determine which areas of the physical space will be visually replaced by virtual elements when areas of the live action environment are painted a solid blue or green color. The keying module can be configured to handle transitions between virtual and real worlds in a game or simulation by reading the image from the front facing camera, performing a color difference key process on the image to remove the solid blue or green elements from the image, and then combining this image with a virtual rendered image. Blue or green paint can be applied on the environment walls, floor, and other objects to allow for automatic transition by the keying module between virtual and real worlds.

Also disclosed herein is a team augmented reality system which includes: a helmet mounted display (HMD) for a user; and means for allowing the user to automatically transition between virtual and real worlds. The means can include at least one forward-facing live action camera mounted on the HMD, and a keying module that is configured to determine whether each portion of the live action image will be displayed to the user or replaced by a virtual rendered image. And the means can be configured to perform the following steps: reading the live action image from a front facing camera, performing a keying operation on the live action image to determine which areas of the live action image should become transparent, and mixing the live action image with a rendered virtual image using transparency data from the keying process to determine the level of visibility of each source image in a final image displayed on the HMD.

Further disclosed herein is a team augmented reality system which includes: a helmet mounted display (HMD) for a user; at least one front facing camera; and means which uses depth information for generating a 3D textured model of physical surroundings of the user wearing the HMD which allows background color and lighting variations of the surroundings to be removed from the live action image before a keying process is performed. The means can be configured to carry out the following steps: detecting edges and corners of surrounding walls, constructing a simplified 3D model of the surrounding environment based on the corners and walls, and projecting the imagery from the live action camera onto the simplified 3D model based on the current position of the user's HMD. The means can include a depth sensor which is connected to the HMD and is mounted to be forward facing in the same direction as the live action camera. And the means can be configured to build a lighting map of blue or green background environment using the following steps: detecting the corners, edges and planes of the surrounding blue or green colored walls, building a simplified 3D model of the environment based upon this geometric information, and projecting the local live action view of the environment onto the simplified environment model based upon the current position and orientation of the HMD.

Even further disclosed herein is a team augmented reality system which includes: a helmet mounted display (HMD) for a user; at least one front facing camera; and means for projecting a virtual blueprint of a physical environment of the user in a display of the HMD. The projecting means can include an outline of the floorplan of the virtual scene located on/in the 3D rendering engine. The blueprint can allow the physical environment to be set up by the user to match a virtual generated environment using the following steps: the HMD can display a mix of the live action and virtual environments, a floorplan of the target environment wall and object locations is projected onto the physical floor through the HMD, and the user can then move actual physical walls and objects to match the position of the virtual environment walls and objects. The means can include a virtual 2D floor blueprint of the target physical 3D environment and which is displayed through the HMD as an overlay on top of the live action image of the physical floor from the front facing camera.

Still further disclosed herein is a system for combining live action and virtual images in real time into a final composite image, which includes: a head mounted display (HMD) through which a user wearing the HMD can view the composite image; a self-contained tracking sensor configured to be used by the HMD; a front facing color image camera attached to the HMD; and a computing device including a color keying based algorithm configured to determine display of real or virtual imagery to the user. The tracking sensor can cover a tracking range of at least 50 m×50 m×10 m due to its ability to track pose by detecting four to five tracking markers and smoothing the pose with an integrated IMU. Also, the tracking sensor can allow the system to be used simultaneously by more than four users due to its ability to calculate its own pose without needing to communicate with an external tracking computer, and this ability is due to the combination of integrated fiducial target recognition, pose calculation, and pose smoothing using an IMU, all contained in one embedded system. And the color keying based algorithm can have the following steps: for each region of a live action image from the front facing camera, measuring the difference between the background blue or green color and the remaining two foreground colors, and using this difference to determine which components of the live action image to preserve and which to remove.

By adding a Spectator VR system as described in copending application No. 62/421,952, and International Application No. PCT/US17/27960, filed Apr. 17, 2017, and which is discussed in the section below, the actions of a group of users immersed in their environment can be viewed, using the similar keying and tracking algorithms as used in the HMD. This provides a spectator with the ability to review or record the activities of the team experience for analysis or entertainment. Since the tracking technology for all groups is based on the same overhead targets and the same reference coordinate system, the positioning remains coherent and the various perspectives are correct for all participants in the system.

### The Spectator VR System

The underlying keying and tracking algorithms and mechanisms between the Spectator VR System and that of the present application are very similar. And this is why both the Spectator VR system and the present system can use the same overhead tracking markers and the same blue/green keying colors. Five aspects of the Spectator VR System which are applicable to the present system are discussed below.

1) The descriptions of the overhead fiducial markers and the algorithms to detect them and solve for the 3D position of those markers (FIG. 1).

In a preferred embodiment, the fiducial markers can be artificial fiducial markers similar to those described in the AprilTag fiducial system developed by the University of Michigan, which is well known to practitioners in the field. To calculate the current position of the tracking sensor in the world, a map of the existing fiducial marker positions is known. In order to both generate a map of the position of the fiducial markers, a nonlinear least squared optimization is performed using a series of views of identified targets, in this case called a ‘bundled solve’, a method that is well known by machine vision practitioners. The bundled solve calculation can be calculated using the open source CERES optimization library by Google Inc. of Mountain View, Calif. (http://ceres-solver.org/nnis_tutorial.html#bundle-adjustment) Since the total number of targets is small, the resulting calculation is small, and can be performed rapidly with a single small computer.

The resulting target map is then matched to the physical stage coordinate system floor. This can be done by placing the tracker on the floor while keeping the targets in sight of the tracking camera. Since the pose of the tracking camera is known and the position of the tracking camera with respect to the floor is known (as the tracking sensor is resting on the floor), the relationship of the targets with respect to the ground plane can be rapidly solved with a single 6DOF transformation, a technique well known to practitioners in the field (described below).

2) The calculation of the pose solve for the self-contained tracker based upon the marker positions (FIG. 1).

Once the overall target map is known and the tracking camera can see and recognize at least four optical markers, the current position and orientation (or pose) of the tracking sensor can be solved. This can be solved with the Perspective 3 Point Problem method described by Laurent Kneip of ETH Zurich in “A Novel Parametrization of the Perspective-Three-Point Problem for a Direct Computation of Absolute Camera Position and Orientation.”

3) The use of an IMU 148 to smooth the pose of the tracker calculated from recognizing the optical markers (FIG. 2) and the use of the PID algorithm to combine the two sources of data (optical pose and IMU smoothing).

Since both the IMU data and the optical data are 6DOF, an important aspect of combining them is to integrate the IMU acceleration twice to generate position data, and then use the optical position data to periodically correct the inherent drift of the IMU's position with a correction factor that includes proportional, integrative and differential components, as is well established in the standard PID control systems loop.

4) The use of a color difference algorithm to separate the blue or green background from the foreground (FIG. 6) and the use of a despill algorithm to remove any blue or green tinting from the separated foreground element (FIG. 6).

The color difference algorithm at each pixel of the image subtracts the foreground color (in the case of a green screen, this would be the values of the red and blue channels of RGB image data) from the background color (this would be the green channel in this case.) This results in a grey scale image with bright values where the green background was visible, and low values where the foreground subject was visible. This image is called a matte, and it can be used to determine which parts of the live action image should be displayed and which should be discarded in the final image.

The despill operation compares the red, blue and green values in a single pixel in the live action image, and then lowers the green level to the max of the blue or red levels. In this way, the resulting image has no areas that appear green to the human eye; this is done to remove the common blue or green ‘fringes’ that appear around the edge of an image processed with a color difference key.

5) The use of a common virtual scene for both the participants of the present disclosure, and the separate Spectator VR camera. Both are using identical (but separate) 3D engines to perform the rendering of identical 3D scenes. For the present system participants, the 3D engine is running on a computer that they are wearing. For the Spectator VR camera, the 3D renderer is running on a separate PC.

Since both participants of the present system and the Spectator VR camera use the same overhead tracking markers to fix their position, and the pose calculations used by the trackers on the Spectator VR camera and the individual users's HMDs use the same markers and the same algorithm, their positions in the virtual scene will be correctly matched to each other, preserving the relative position between the two that exists in the real world, and enabling an external viewer to observe the actions of a team of participants from the point of view of a moving camera operator.

Since a self-contained tracker can be attached to the user's hand controller/gun, as well as to moving objects in the scene, an immersive environment can be created with blue or green moving objects being replaced in real time by their virtual replacements. This is can extend to the user's own tools, which can become different weapons or implements, depending on the task at hand.

In addition, since the user can see both virtual and live action representations of objects at the same time, it becomes straightforward to match the physical scene to the contours of the pre-generated virtual scene by projecting a “floorplan” onto the physical floor of the environment, so that workers wearing the HMD devices can then align the walls and objects to their correct locations.

### BRIEF DESCRIPTION OF THE DRAWINGS

The foregoing and other features and advantages of the present invention will be more fully understood from the following detailed description of illustrative embodiments, taken in conjunction with the accompanying drawings.

FIG. 1 is a perspective view of an embodiment in accordance with the present disclosure.

FIG. 2 is a perspective view of an embodiment in accordance with the present disclosure.

FIG. 3 is a schematic view of an embodiment in accordance with the present disclosure.

FIG. 4 is a perspective view of a user wearing an HMD, a portable computer, and tracking sensors in accordance with an embodiment of the present disclosure.

FIG. 5 is a data flow chart describing the movement of tracking and imagery data in accordance with an embodiment of the present disclosure.

FIG. 6 is a perspective view of a user facing a set of walls in accordance with an embodiment of the present disclosure.

FIG. 7 depicts a physical structure before and after being combined with virtual elements in accordance with the present disclosure.

FIG. 8 is a perspective view of a user interacting with a physical prop in accordance with the present disclosure.

FIG. 9 is a perspective view of two users being viewed by a third person camera operator in accordance with the present disclosure.

FIG. 10 is a perspective view of several physical scene elements in accordance with the present disclosure.

FIG. 11 depicts the user's hand weapon before and after being combined with virtual elements in accordance with the present disclosure.

FIG. 12 is a perspective view of physical scene elements being assembled to align with a virtual projection of the floorplan in accordance with the present disclosure.

FIG. 13 is a block diagram that depicts the steps for user operation of a team AR system in accordance with the present disclosure.

### DETAILED DESCRIPTION

The following is a detailed description of presently known best mode(s) of carrying out the inventions. This description is not to be taken in a limiting sense, but is made for the purpose of illustrating the general principles of the inventions.

A rapid, efficient, reliable system is disclosed herein for combining live action images on a head mounted display that can be worn by multiple moving users with matching virtual images in real time. Applications ranging from video games to military and industrial simulations can implement the system in a variety of desired settings that are otherwise difficult or impossible to achieve with existing technologies. The system thereby can greatly improve the visual and user experience, and enable a much wider usage of realistic augmented reality simulation.

The process can work with a variety of head mounted displays and cameras that are being developed.

An objective of the present disclosure is to provide a method and apparatus for rapidly and easily combining live action and virtual elements in a head mounted display worn by multiple moving users in a wide area.

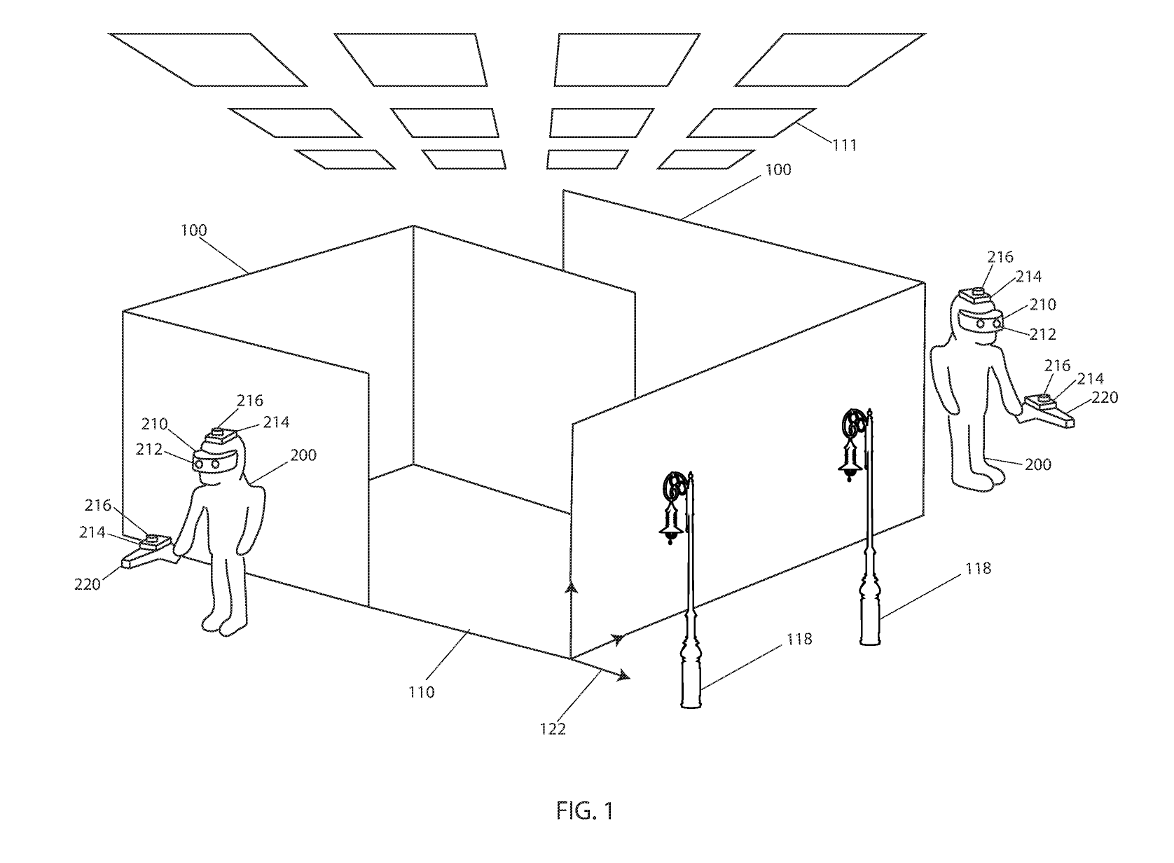

FIG. 1 depicts an embodiment of the present disclosure. At least one user 200 wears a HMD 210 with one or more front facing cameras 212 to provide a live action view of the environment. A self-contained tracking sensor 214 with at least one upward-facing tracking camera 216 is rigidly mounted to the HMD 210 so that tracking camera 216 can see overhead tracking markers 111. HMD 200 has a low-latency data connection between front facing cameras 212 and the eyepieces of HMD 200, so that the user 200 can see a realistic augmented view of the surrounding environment. This HMD can be a Totem low latency display made by the VRVana Company of Monteal, Canada. The self-contained tracking sensor 214 can be the Halide Tracker made by Lightcraft Technology of Santa Monica, Calif.

User 200 can carry at least one hand controller 220; in this embodiment it is displayed as a gun. Hand controller 220 also has a self-contained tracking sensor 214 with upward facing lens 216 mounted rigidly to it. The users 200 are moving through an area which optionally has walls 100 to segment the simulation area. Walls 100 and floor 110 may be painted a solid blue or green color to enable a real time keying process that selects which portions of the real world environment will be replaced with virtual imagery. The walls 100 are positioned using world coordinate system 122 as a global reference. World coordinate system 122 can also be used as the reference for the virtual scene, to keep a 1:1 match between the virtual and the real world environment positions. There is no need to have walls 100 for the system to work, and the system can work in a wide open area.

One of the system advantages is that it can work in environments with many high physical walls 100, which are frequently needed for realistic environment simulation. Physical props 118 can also be placed in the environment. They can be colored a realistic color that does not match the blue or green keyed colors, so that the object that the user may touch or hold (such as lamp posts, stairs, or guard rails) can be easily seen and touched by the user with no need for a virtual representation of the object. This also makes safety-critical items like guardrails safer, as there is no need to have a perfect VR recreation of the guardrail that is registered 100% accurately for the user to be able to grab it.

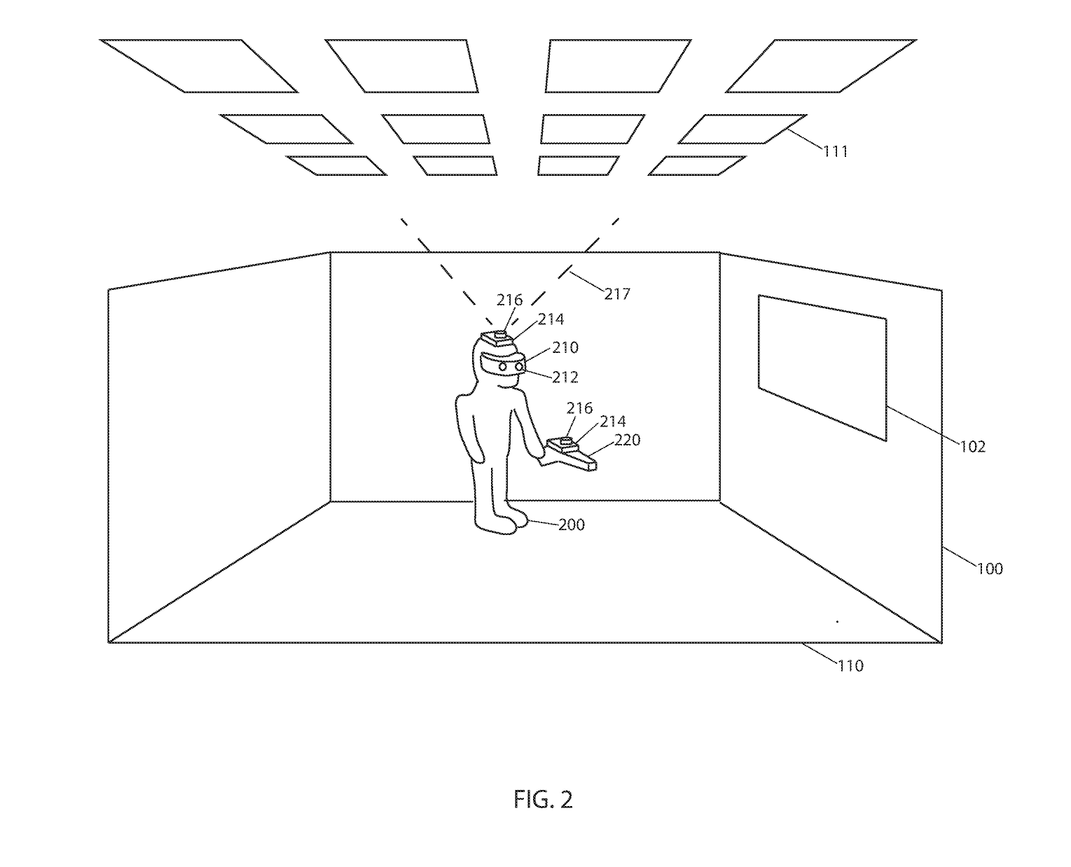

An embodiment of the present disclosure is illustrated in FIG. 2. As before, user 200 wears HMD 210 with front facing cameras 212, and a rigidly mounted self-contained tracker 214 with upward-facing tracking camera 216. Tracking camera 216 can have a wide field of view 217; this field of view can be ninety degrees, for example. Tracking camera 216 can then view overhead tracking targets 111. Tracking targets 111 can use a variety of technologies, including active emitters, reflective, and any technology that can be viewed by a tracking sensor. These tracking targets can be fiducial markers similar to those described by the AprilTag system developed by the University of Michigan, which is well known to practitioners in the field.

User 200 can be surrounded by walls 100 and floor 110, optionally with openings 102. Since most existing VR tracking technologies require a horizontal line of sight to HMD 210 and hand controller 220, the use of high walls 100 prevents those technologies from working. The use of self-contained tracking sensor 214 with overhead tracking targets 111 enables high walls 100 to be used in the simulation, which is important to maintain a sense of simulation reality, as one user 200 can see other users 200 (or other scene objects not painted a blue or green keying color) through the front facing cameras 212. As previously noted, most other tracking technologies depend upon an unobstructed sideways view of the various users in the simulation, preventing realistically high walls from being used to separate one area from another. This lowers the simulation accuracy, which can be critical for most situations.

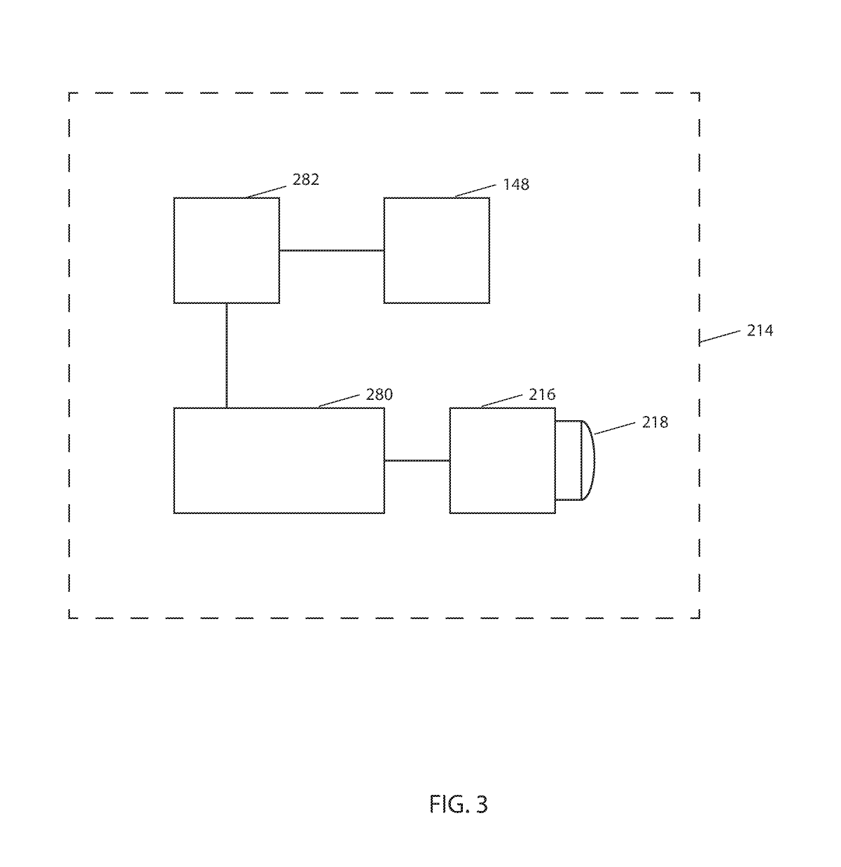

To calculate the current position of the tracking sensor 214 in the world, a map of the existing fiducial marker 3D positions 111 is known. In order to generate a map of the position of the optical markers 111, a nonlinear least squared optimization is performed using a series of views of identified optical markers 111, in this case called a ‘bundled solve’, a method that is well known by machine vision practitioners. The bundled solve to calculation can be calculated using the open source CERES optimization library by Google Inc. of Mountain View, Calif. (http://ceres-solver.org/nnls_tutorial.html#bundle-adjustment) Since the total number of targets 111 is small, the resulting calculation is quick, and can be performed rapidly with an embedded computer 280 (FIG. 3) contained in the self-contained tracking sensor 214.

Once the overall target map is known and tracking camera 216 can see and recognize at least four optical markers 111, the current position and orientation (or pose) of tracking sensor 214 can be solved. This can be solved with the Perspective 3 Point Problem method described by Laurent Kneip of ETH Zurich in “A Novel Parametrization of the Perspective-Three-Point Problem for a Direct Computation of Absolute Camera Position and Orientation.” Since the number of targets 111 is still relatively small (at least four, but typically less than thirty), the numerical solution to the pose calculation can be solved very rapidly, in a matter of milliseconds on a small embedded computer 280 contained in the self-contained tracking sensor.

Once the sensor pose can be solved, the resulting overhead target map can then be referenced to the physical stage coordinate system floor 110. This can be achieved by placing tracking sensor 214 on the floor 110 while keeping the targets 111 in sight of tracking camera 216. Since the pose of tracking camera 216 is known and the position of tracking camera 216 with respect to the floor 110 is known (as the tracking sensor 214 is resting on the floor 110), the relationship of the targets 111 with respect to the ground plane 110 can be rapidly solved with a single 6DOF transformation, a technique well known to practitioners in the field.

After the overall target map is known and reference to the floor 110, when the tracking sensor 214 can see at least four targets 111 in its field of view, it can calculate the position and orientation, or pose, anywhere under the extent of targets 111, which can cover the ceiling of a very large space (for example, 50 m×50 m×10 m.)

A schematic of an embodiment of the present disclosure is shown in FIG. 3. Tracking sensor 214 contains an IMU 148 that is used to smooth out the sensor position and orientation, or pose, calculated previously from recognizing optical markers 111, which can otherwise generate noisy data that is not suitable for tracking HMD 210. IMU 148 is connected to a microcontroller 282, which is also connected to embedded computer 280. Embedded computer 280 is also connected to camera 216 with wide angle lens 218. Microcontroller 282 continuously combines the optical camera pose from embedded computer 280 with the high speed inertial data from IMU 148 using a PID (Proportional, Integral, Derivative) method to resolve the error between the IMU pose and the optical marker pose. The PID error correction method is well known to practitioners in real time measurement and tracking. The IMU 148 can be a six degree of freedom IMU from Analog Devices of Norwood, Mass. And the embedded computer can be an Apalis TK1 single board computer from Toradex AG of Lucerne, Switzerland. Additionally, the microcontroller 282 can be a 32-bit microcontroller from Atmel Corporation of San Jose, Calif.

The field of view of the lens 218 on tracking camera 216 is a trade-off between what the lens 218 can see and the limited resolution that can be processed in real time. This wide angle lens 218 can have a field of view of about ninety degrees, which provides a useful trade-off between the required size of optical markers 111 and the stability of the optical tracking solution.

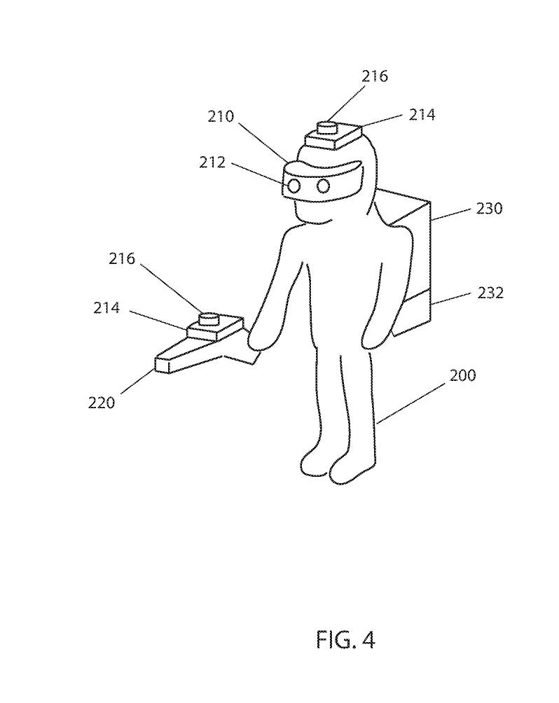

An embodiment of the present disclosure is illustrated in FIG. 4. A user 200 wears a HMD 210 with one or more front facing cameras 212 to provide the live action view of the environment. A self-contained tracking sensor 214 with at least one upward-facing tracking camera 216 is rigidly mounted to the HMD 210. HMD 200 has a low-latency data connection between front facing cameras 212 and the eyepieces of HMD 200, so that the user 200 can see a realistic augmented view of the surrounding environment. User 200 can carry at least one hand controller 220; in this embodiment it is shown as a gun. Hand controller 220 also has a self-contained tracking sensor 214 with upward facing lens 216 mounted rigidly to it. User 200 also wears a portable computer 230 and battery 232. This portable computer 230 contains the rendering hardware and software to drive the eye displays in HMD 210, and has a data connection to both self contained trackers 214. This data connection can be a standard serial data link that may be wired or wireless.

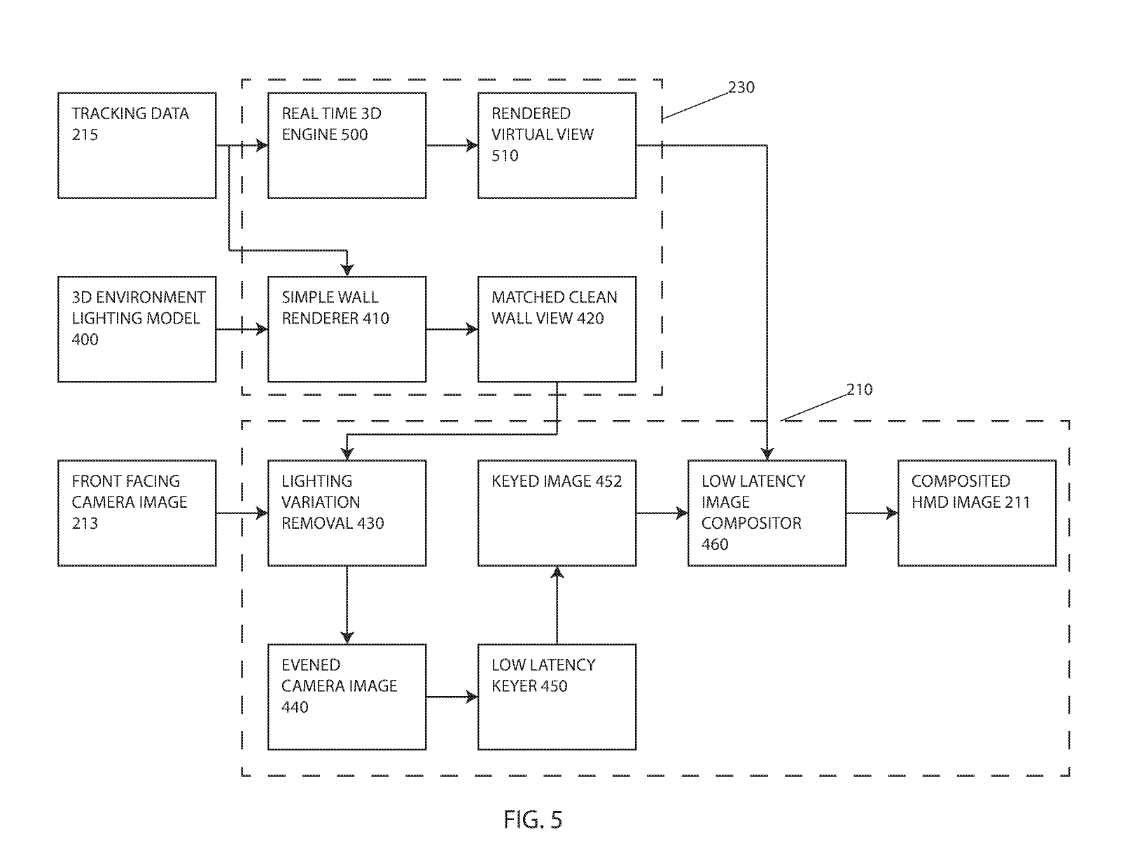

The data flow of the tracking and imaging data is illustrated in FIG. 5. Self-contained tracking sensors 214 generate tracking data 215 that comes into portable computer 230 over a data link. Portable computer 230 has multiple pieces of software running on it, including a real time 3D engine 500 and a simple wall renderer 410. 3D engine 500 can be one of a variety of different real time engines, depending upon the application. The 3D engine 500, for example, can be the Unreal Engine made by Epic Games of Cary, N.C. Most of the various types of real time engines are designed to handle the rendering of a single player, but can communicate over a standard computer network to a large number of other computers running the same engine simultaneously. In this way, the communication between different computers is reduced to sending the current player actions over the network, which is low bandwidth communication and already well established by practitioners in the art. 3D engine 500 uses the incoming tracking data 215 from self contained trackers 214 to generate a rendered virtual view 510 from a perspective matched to the current position of HMD 210.

Tracking data 215 is passed to both 3D engine 500 and wall renderer 410. Wall renderer 410 can be a simple renderer that uses the wall position and color data from a 3D environment lighting model 400 to generate a matched clean wall view 420. 3D environment lighting model 400 can be a simple 3D model of the walls 100, the floor 110, and their individual lighting variations. Since real time keying algorithms that separate blue or green colors from the rest of an image are extremely sensitive to lighting variations within those images, it is advantageous to remove those lighting variations from the live action image before attempting the keying process. This process is disclosed in U.S. Pat. No. 7,999,862. Wall renderer 410 uses the current position tracking data 215 to generate a matched clean wall view 420 of the real world walls 100 from the same point of view that the HMD 210 is presently viewing those same walls 100. In this way, the appearance of the walls 100 without any moving subjects 200 in front of them is known, which is useful for making keying an automated process. This matched clean wall view 420 is then passed to the lighting variation removal stage 430.

As previously noted, HMD 210 contains front facing cameras 212 connected via a low-latency data connection to the eye displays in HMD 210. This low latency connection is important to users being able to use HMD 210 without feeling ill, as the real world representation needs to pass through to user 200's eyes with absolute minimum latency. However, this low latency requirement can drive the constraints on image processing in unusual ways. As previously noted, the algorithms used for blue and green screen removal are sensitive to lighting variations, and so typically require modifying their parameters on a per-shot basis in traditional film and television VFX production. However, as the user 200 is rapidly moving his head around, and walking around multiple walls 100, the keying process must become more automated. By removing the lighting variations from the front facing camera image 213, it becomes possible to cleanly replace the physical appearance of the blue or green walls 100 and floor 110, and rapidly and automatically provide a high quality, seamless transition between the virtual environment and the real world environment for the user 200.

This is achieved with the following steps, and can take place on portable computer 230 or in HMD 210. This can take place, for example, on HMD 210 inside very low latency circuitry. The front facing camera image 213 along with the matched clean wall view 420 are passed to the lighting variation removal processor 430. This lighting variation removal uses a simple algorithm to combine the clean wall view 420 with the live action image 213 in a way that reduces or eliminates the lighting variations in the blue or green background walls 100, without affecting the non-blue and non-green portions of the image. This can be achieved by a simple interpolation algorithm, described in U.S. Pat. No. 7,999,862, that can be implemented on the low latency circuitry in HMD 210. This results in evened camera image 440, which has had the variations in the blue or green background substantially removed. Evened camera image 440 is then passed to low latency keyer 450. Low latency keyer 450 can use a simple, high speed algorithm such as a color difference method to remove the blue or green elements from the scene, and create keyed image 452. The color difference method is well known to practitioners in the field. Since the evened camera image 440 has little or no variation in the blue or green background lighting, keyed image 452 can be high quality with little or no readjustment of keying parameters required as user 200 moves around the simulation area and sees different walls 100 with different lighting conditions.

Keyed image 452 is then sent to low latency image compositor 460 along with the rendered virtual view 510. Low latency image compositor 460 can then rapidly combine keyed image 452 and rendered virtual view 510 into the final composited HMD image 211. The image combination at this point becomes very simple, as keyed image 452 already has transparency information, and the image compositing step becomes a very simple linear mix between virtual and live action based upon transparency level.

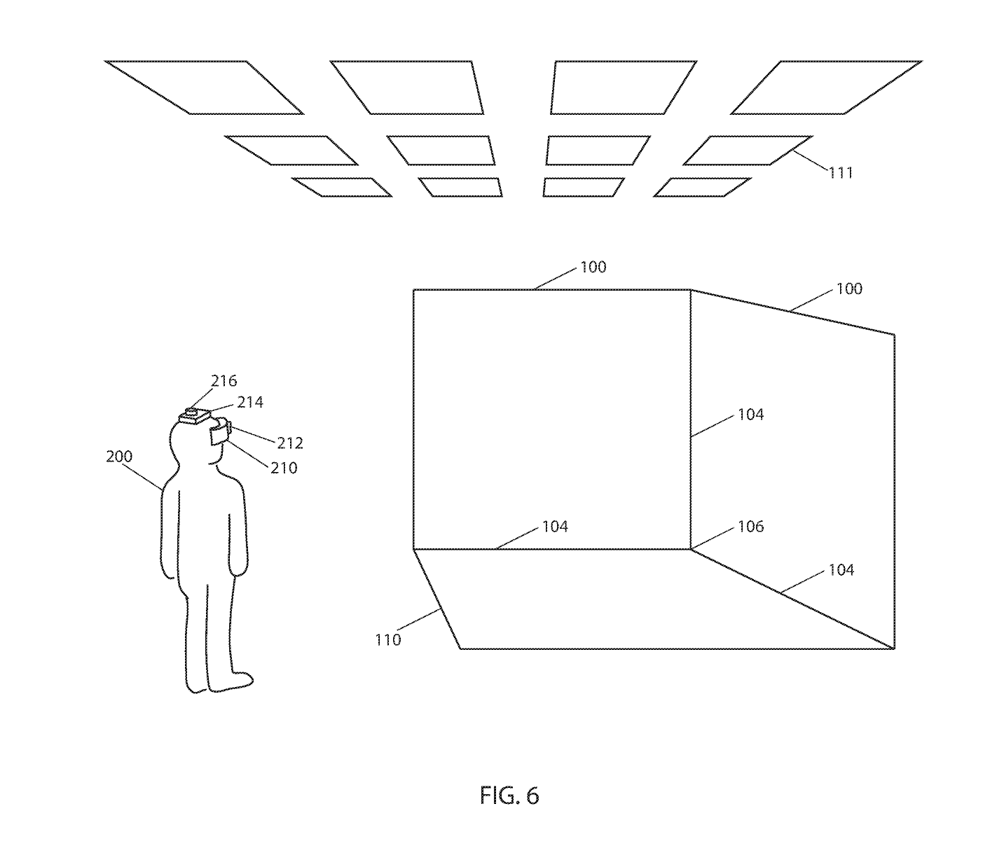

A perspective view of the system is illustrated in FIG. 6. User 200 wears a HMD 210 with one or more front facing cameras 212 to provide the live action view of the walls 100 and floor 110. A self-contained tracker 214 with at least one upward-facing tracking camera 216 is rigidly mounted to the HMD 210. HMD 200 has a low-latency data connection between front facing cameras 212 and the eyepieces of HMD 200, so that the user 200 can see a realistic augmented view of the surrounding environment. Tracking camera 216 is oriented upwards to see tracking markers 111 mounted on the ceiling of the environment. Front facing cameras 212 can be used to generate depth information using stereo vision techniques that are well known to practitioners in the field. In an alternative embodiment, a separate dedicated depth sensor can be used to detect depth information in the area that user 200 is looking at. Walls 100 and floor 110 can be painted a solid blue or green color to assist with the keying process. This color can be Digital Green or Digital Blue, manufactured by Composite Components Corporation of Los Angeles, Calif. Common depth calculation techniques used with two cameras (typically called stereo vision by practitioners in the field) require that regions of high frequency detail be matched between the images of the two cameras to calculate the distance from the cameras.

Since the walls in this embodiment are painted a solid color to aid the keying process, it will typically be difficult to measure the actual wall using stereo depth to processing methods. However, edges 104 and corners 106 typically provide areas of high contrast, even when painted a solid color, and can be used to measure the depth to the edges 104 and corners 106 of walls 100. This would be insufficient for general tracking use, as corners are not always in view. However, combined with the overall 3D tracking data 215 from self-contained tracking sensor 214, this can be used to calculate the 3D locations of the edges 104 and corners 106 in the overall environment. Once the edges and corners of walls 100 are known in 3D space, it is straightforward to determine the color and lighting levels of walls 100 by having a user 200 move around walls 100 until their color and lighting information (as viewed through front facing cameras 212) has been captured from every angle and applied to 3D environment lighting model 400. This environment lighting model 400 is then used as described in FIG. 5 to remove the lighting variations from the front facing camera images 213 before going through the keying process.

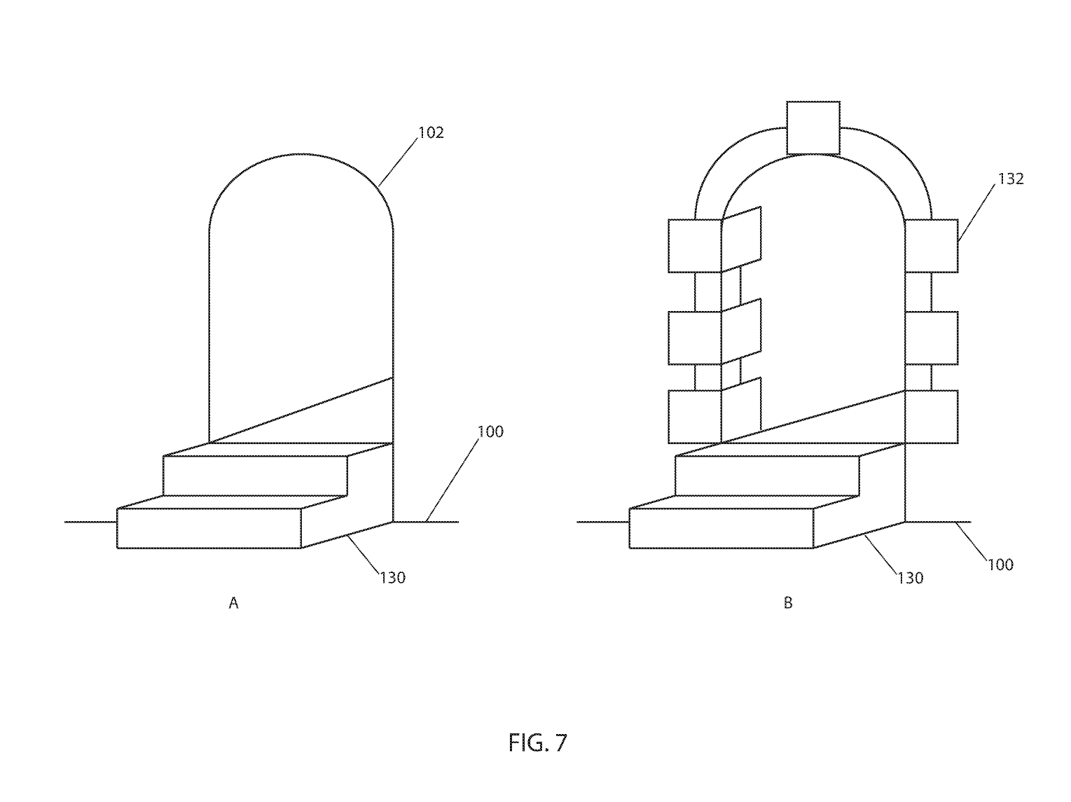

A view of the image before and after compositing is shown in FIG. 7. In section A, a wall 100 has an opening 102 and a staircase 130 leading up to opening 102. In this embodiment, wall 100 is painted a solid blue or green color, and staircase 130 is painted a different contrasting color. Through the process described in FIG. 5, the green wall 100 is visually replaced in section B with a more elaborate texture 132 to simulate a realistic building. However, staircase 130 passes through to the user's HMD display unaffected, so that users can accurately and safely step on real stairs (as they can see exactly where to put their feet.) In this way, the display of objects can be rapidly and easily controlled by simply painting the object different colors, so that live action objects that need to be seen clearly for safety or simulation purposes can be seen exactly as they appear in normal settings, while any objects that need to be replaced can be painted blue or green and will thus be replaced by virtual imagery. Objects can even be partially replaced, by painting only a portion of them blue or green. Since the keying methods are usually built around removing one color, the site will need to choose whether to use blue or green as the primary keying color with which to paint the walls 100 and floor 110.

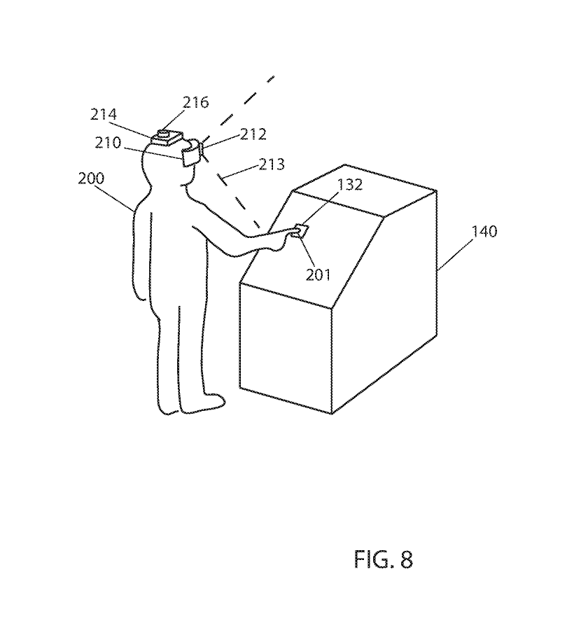

Another goal of the system is illustrated in FIG. 8. A user 200 wears a HMD 210 with one or more front facing cameras 212 to provide the live action view of the environment. A self-contained tracking sensor 214 with at least one upward facing tracking camera 216 is rigidly mounted to the HMD 210. HMD 200 has a low-latency data connection between front facing cameras 212 and the eyepieces of HMD 200, so that the user 200 can see a realistic augmented view of the surrounding environment. As noted before, multiple front facing cameras 212 can be used to calculate the distance to various scene objects from HMD 210. The field of view 213 of the front facing cameras 212 determines the area where distance can be detected. In this way, virtual environment buttons or controls 132 can be made on scene objects 140. By detecting the location of the user's finger 201, comparing it to a virtual model of the scene, and detecting whether the user's finger 201 intersects the 3D location of the virtual button 132, the user can interact with various controls in the virtual scene. This can be useful for training and simulation, as well as for games. The detection and recognition of fingers and hand position with stereo cameras is well understood by practitioners in machine vision.

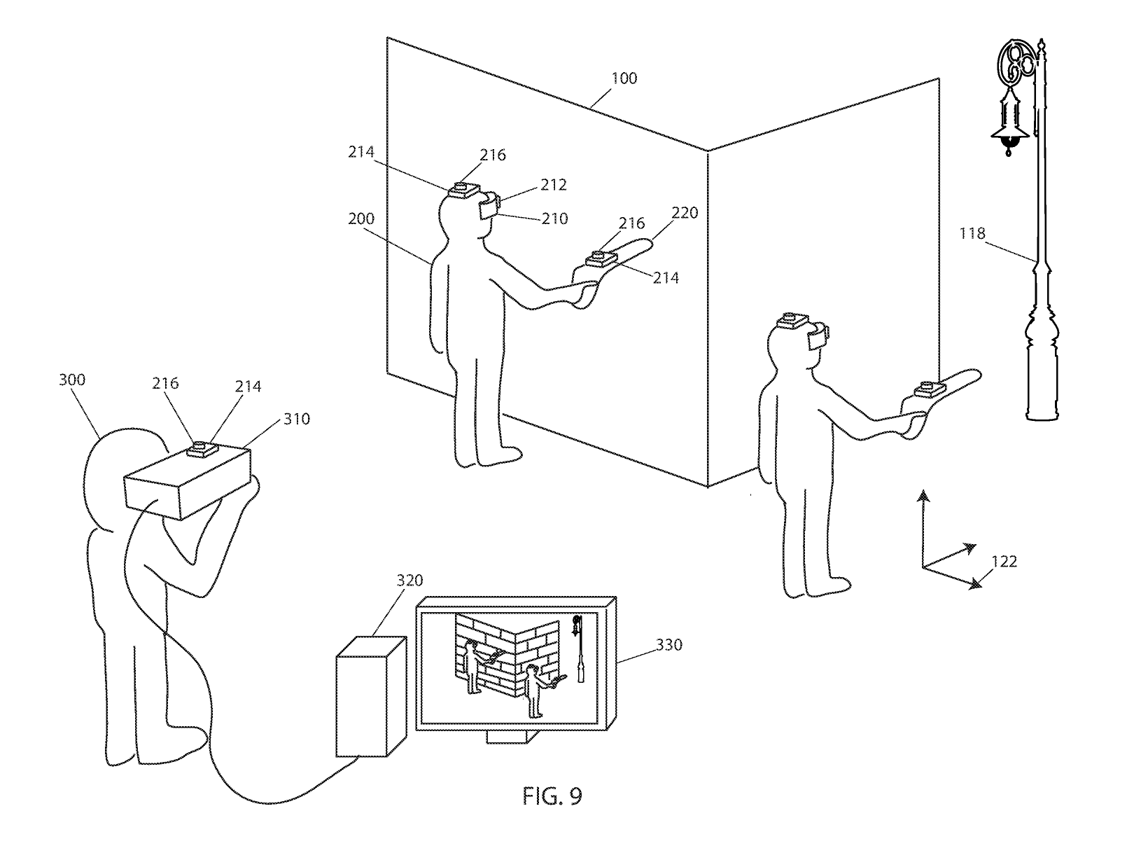

A perspective view of the present embodiment is shown in FIG. 9. In this case, multiple users 200, each with HMDs 210, hand controllers 220, and self-contained trackers 214, are walking through the environment with walls 100, physical props 118 and world coordinate system 122. They are being viewed by camera operator 300 with video camera 310 connected to another self-contained tracking sensor 214 with upward-facing tracking camera 216. This tracker 214 and video camera 310 is connected to a spectator VR system 320 with viewing monitor 330. This Spectator VR system can be the Halide FX system made by Lightcraft Technology of Los Angeles, Calif., and discussed earlier in this disclosure. Since the spectator VR system uses the same overhead tracking markers 111 as the other self contained trackers 214, and the same world coordinate system 122 as the rest of the 3D engines, the viewing monitor 330 displays a composited view of the users 200 immersed in the virtual environment created by 3D engine 500. The painted walls 100 are replaced by a virtual wall image, but the users 200 and physical props 118 appear without visual modification. This provides a rapid way for other people to see what the group of users 200 is doing for entertainment or evaluation.

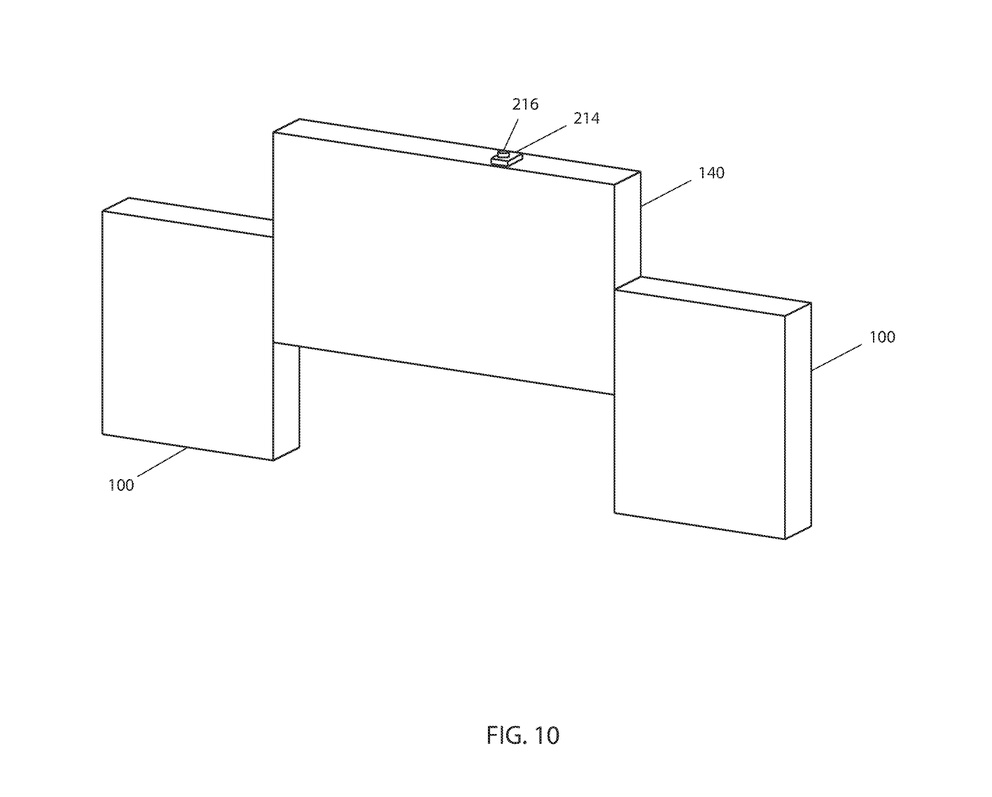

A perspective view of the present embodiment is shown in FIG. 10. Stationary walls 100 are on either side of a moving scene element 140 with a self-contained tracking sensor 214. Since the tracking camera 216 also faces upwards to see the same tracking targets 111 as the rest of the system, the current position of a moving scene object 140 can be integrated into the rest of the simulation for all of the users 200 simply by streaming the current position of tracking sensor 214 to the 3D engines. This can be accomplished by using the standard network protocols for moving objects that have been established in the multiplayer first person shooter video games, and are well known to practitioners in the art. The moving scene object 140 can be painted blue or green in the same color as walls 100, and have a visually detailed rendered version shown to the user instead. This makes it possible to have moving doors, vehicles, and other objects in the scene that are automatically integrated into the overall user experience for the group.

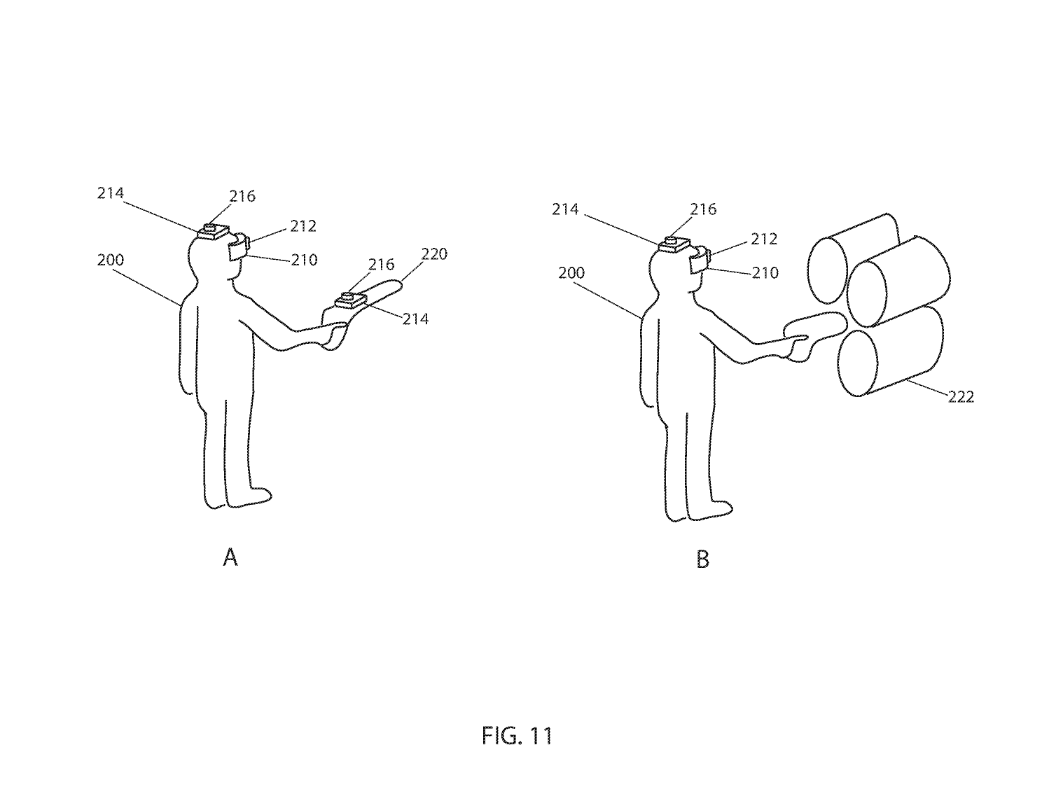

FIG. 11 is a perspective illustration of the system showing before and after views of the user's hand controller. Section A shows the unmodified view of user 200 and hand controller 220. Hand controller 220 also has a self-contained tracking sensor 214 with upward facing lens 216 mounted rigidly to it. If hand controller 220 is painted green, and 3D engine 500 is provided with a replacement visual model 222, when viewed by other users 200 through HMD 210 or with the spectator VR system 320 the other users will see the image shown in section B where visual model 222 is seen instead of hand controller 220.

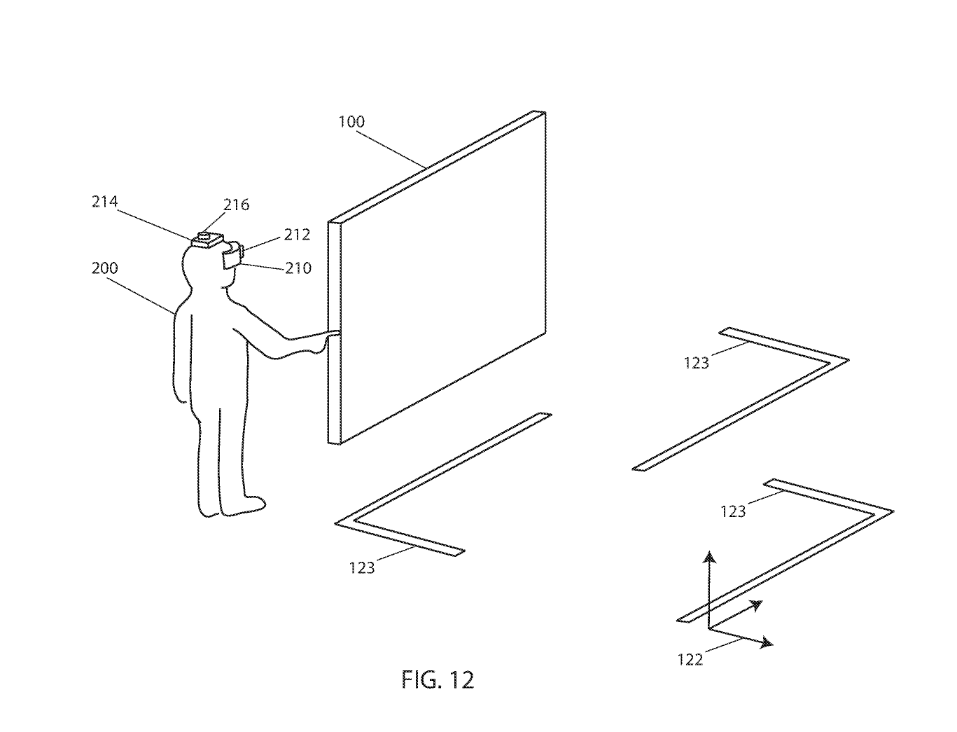

A perspective view of the physical environment being set up is shown in FIG. 12. User 200 again wears HMD 210 with self-contained tracking sensor 214 and tracking camera 216. User 200 is moving wall 100 in place to match the virtual environment. In this case, a virtual floorplan 123 is shown to user 200 when viewing it through HMD 210, so that the user can precisely position the wall 100 to align correctly with the virtual environment. The virtual floorplan 123 is positioned with respect to the same world coordinate system 122, so that the physical and the virtual components of the scene will line up correctly. During the wall assembly procedure, wall 100 can be temporarily colored a color that is not blue or green, so that user 200 can more easily see it through HMD 210.

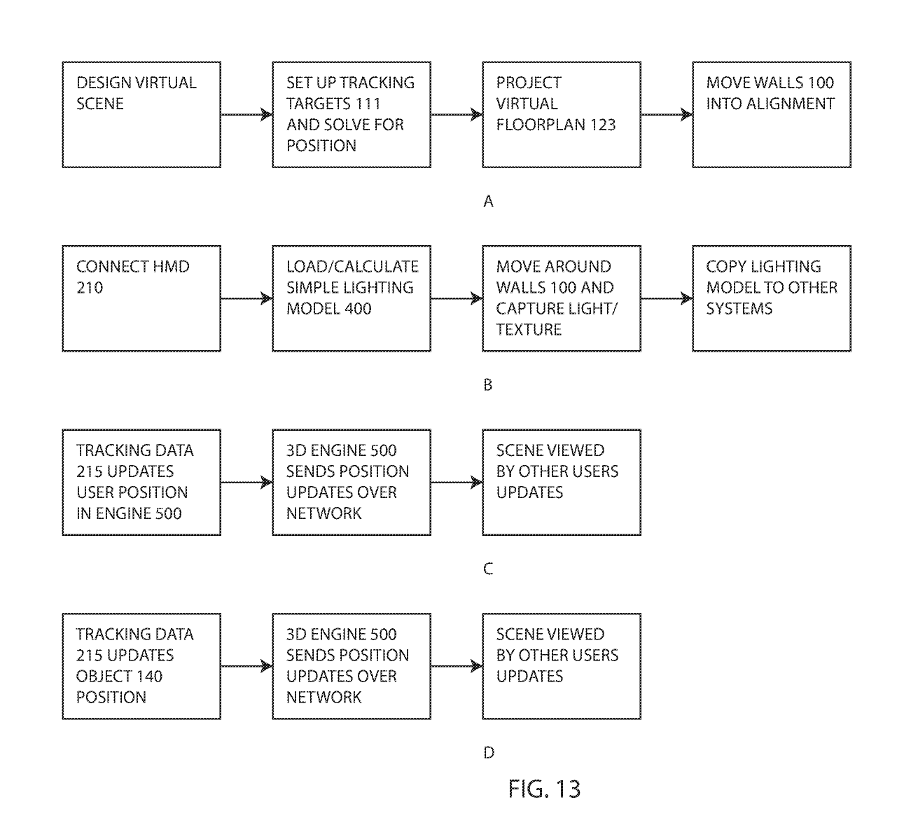

A block diagram showing the method of operations is shown in FIG. 13. Section A covers the initial setup and alignment of the tracking markers and objects in the scene. First, the virtual scene is designed, typically using standard 3D content creation tools in 3D engine 500. These tools are well understood by practitioners in the art. The content creation tool, for example, can be Maya, made by Autodesk Corporation of San Rafael, Calif. Next, tracking targets 111 are placed on the ceiling and their 3D location with respect to world coordinate system 122 is determined. This can be achieved with a bundled solve method as previously described. This can be performed by the Halide FX Tracker made by Lightcraft Technology of Santa Monica, Calif. Next, the virtual floorplan 123 is loaded into 3D engine 500, which is just the 2D outlines of where walls 100 will rest on floor 110. The user 200 can then look through HMD 210 and see precisely where walls 100 are supposed to be placed. In the final step, walls 100 are placed on top of virtual floorplan 123.

Section B shows a method of generating the lighting model 400. Once the HMD 210 is tracking with respect to the overhead tracking targets 111 and the world coordinate system 122, the basic 3D geometry of the walls is established. This can be achieved either by loading a very simple geometric model of the locations of the walls 100, or determined by combining the distance measurements from stereo cameras 212 on HMD 210 to calculate the 3D positions of edges 104 and corners 106 of walls 100. Once the simplified 3D model of the walls 100 is established, user 200 moves around walls 100 so that every section of walls 100 is viewed by the cameras 212 on HMD 210. The color image data from cameras 212 is then projected onto the simplified lighting model 400, to provide an overall view of the color and lighting variations of walls 100 through the scene. Once this is complete, simple lighting model 400 is copied to the other portable computers 230 of other users.

Section C shows a method of updating the position of user 200 and hand controller 220 in the simulation. The tracking data 215 from self contained trackers 214 mounted on HMD 210 and hand controller 220 is sent to the real time 3D engine 500 running on the user's portable computer 230. The 3D engine 500 then sends position updates for the user and their hand controller over a standard wireless network to update the other user's 3D engines. The other users' 3D engines update once they receive the updated position information, and in this way all the users stay synchronized with the overall scene.

A similar method is shown in Section D for the updates of moving scene objects. The tracking data 215 is sent to a local portable computer 230 running a build of the 3D engine 500, so that the position of the moving scene object 140 is updated in the 3D engine 500. 3D engine 500 then transmits the updated object position on a regular basis to the other 3D engines 500 used by other players, so the same virtual object motion is perceived by each player.

In an alternative embodiment, the depth information from the stereo cameras 212 can be used as part of the keying process, either by occluding portions of the live action scene behind virtual objects as specified by their distance from the user, or by using depth blur instead of the blue or green screen keying process as a means to separate the live action player in the foreground from the background walls. There are multiple techniques to get a clean key, some of which do not involve green screen such as difference matting, so other technologies to separate the foreground players from the background walls can also be used.

Thus, systems of the present disclosure can have many unique advantages such as those discussed immediately below. Since each tracking sensor 214 is self contained and connected to an individual portable computer 230, the system can scale to very large numbers of users (dozens or hundreds) in a single location, without compromising overall tracking or system stability. In addition, since each tracking sensor 214 has an upward facing camera 216 viewing tracking targets 111, many users can be very close together without compromising the tracking performance of the system for any individual user. This is important for many simulations like group or team scenarios. Since the portable computers 230 are running standard 3D engines 500 which already have high speed communication over standard wifi type connnections, the system scales in the same way that a standard gaming local area network scales, which can handle dozens or hundreds of users with existing 3D engine technology that is well understood by practitioners in the art.

The use of a low latency, real time keying algorithm enables a rapid separation between which portions of the scene are desired to be normally visible, and which portions of the scene will be replaced by CGI. Since this process can be driven by the application of a specific paint color, virtual and real world objects can be combined by simply painting one part of the real world object the keyed color. In addition, due to the upward-facing tracking camera and use of overhead tracking targets, the system can easily track even when surrounded by high walls painted a single uniform color, which would make traditional motion capture technologies and most other VR tracking technologies fail. The green walls can be aligned with the CGI versions of these walls, so that players can move through rooms and into buildings in a realistic manner, with a physical green wall transformed into a visually textured wall that can still be leaned against or looked around.

The keying algorithm can be implemented to work at high speed in the type of low latency hardware found in modern head mounted displays. This makes it possible for users to see their teammates and any other scene features not painted the keying color as they would normally appear, making it possible to instantly read each other's body language and motions, and enhancing the value of team or group scenarios. In addition, using the depth sensing capability of the multiple front facing cameras 212, a simplified 3D model of the walls 100 that has all of the color and lighting variations can be captured. This simple 3D lighting model can then be used to create a “clean wall” image of what a given portion of the walls 100 would look like without anyone in front of them, which is an important element to automated creation of high quality real time keying. It is also possible to track the users' finger position based on the HMD position and the depth sensing of the front facing cameras, and calculate whether the user's hand has intersected a virtual “control switch” in the simulation.

A third person “spectator VR” system can also be easily integrated into the overall whole, so that the performance of the users while integrated into the virtual scene can be easily witnessed by an external audience for entertainment or analysis. In addition, it is straightforward to add the use of moving tracked virtual “obstacles, ” whose positions are updated in real time across all of the users in the simulation. The same methods can be used to overlay the visual appearance of the user's hand controller, showing an elaborate weapon or control in place of a more pedestrian controller. Finally, a projected “blueprint” 123 can be generated on the floor 110 of the system, enabling rapid alignment of physical walls 100 with their virtual counterparts.

In an alternative embodiment, the walls 100 can be visually mapped even if they are not painted a blue or green, to provide a difference key method to remove the background without needing a blue or green component.

### SUMMARIES OF SELECTED ASPECTS OF THE DISCLOSURE

1. A team augmented reality system that uses self-contained tracking systems with an upward-facing tracking sensor to track the positions of large numbers of simultaneous users in a space.

The system uses an upward-facing tracking sensor to detect overhead tracking markers, thus making it unaffected by objects near the user, including large numbers of other users or high walls that are painted a single color. Since the tracking system is contained with the user, and does not have any dependencies on other users, the tracked space can be very large (50 m×50 m×10 m) and the number of simultaneous users in a space can be very large without overloading the system. This is required to achieve realistic simulation scenarios with large numbers of participants.

2. A HMD with a low latency keying algorithm to provide a means to seamlessly mix virtual and live action environments and objects.

The use of a keying algorithm enables a rapid, simple way of determining which components of the environment are to be passed through optically to the end user, and which components are to be replaced by virtual elements. This means that simulations can freely mix and match virtual and real components to best fit the needs of the game or simulation, and the system will automatically handle the transitions between the two worlds.

3. A team augmented reality system that lets users see all the movements of the other members of their group and objects not the keyed color.

Further to #1 above, a player can see his other teammates automatically in the scene, as they are not painted green. The system includes the ability to automatically transition between the virtual and real worlds with a simple, inexpensive, easy to apply coat of paint.

4. A team augmented reality system that uses depth information to generate a 3D textured model of the physical surroundings, so that the background color and lighting variations can be rapidly removed to improve the real time keying results.

The success or failure of the keying algorithms depends on the lighting of the green or blue walls. If the walls have a lot of uneven lighting and the keying algorithm cannot compensate for this, the key may not be very good, and the illusion of a seamless transition from live action to virtual will be compromised. However, automatically building the lighting map of the blue or green background environment solves this problem automatically, so that the illusion works no matter which direction the user aims his head.

5. A team augmented reality system that can incorporate a third person “spectator AR” system for third person viewing of the team immersed in their environment.

The ability to see how a team interacts is key to some of the educational, industrial and military applications of this technology. The system includes the common tracking origin made possible by the use of the same overhead tracking technology for the users as for the spectator VR camera. It also means that the camera operator can follow the users and track wherever they will go inside the virtual environment.

6. A team augmented reality system that can project a virtual “blueprint” in the displays of users, so that the physical environment can be rapidly set up to match the virtual generated environment.

This system feature helps set up the environments; otherwise it is prohibitively difficult to align everything correctly between the virtual world and the live action world.

Although the inventions disclosed herein have been described in terms of preferred embodiments, numerous modifications and/or additions to these embodiments would be readily apparent to one skilled in the art. The embodiments can be defined, for example, as methods carried out by any one, any subset of or all of the components as a system of one or more components in a certain structural and/or functional relationship; as methods of making, installing and assembling; as methods of using; methods of commercializing; as methods of making and using the units; as kits of the different components; as an entire assembled workable system; and/or as sub-assemblies or sub-methods. The scope further is includes apparatus embodiments/claims versions of method claims and method embodiments/claims versions of apparatus claims. It is intended that the scope of the present inventions extend to all such modifications and/or additions.

1. A system comprising:
a helmet mounted display (HMD) for a user;
a front-facing camera or cameras; and
a low latency keying module configured to mix virtual and live action environments and objects in an augmented reality game or simulation.

2. The system of claim 1 wherein the keying module is configured to composite the live action image from the front facing camera with a rendered virtual image from the point of view of the HMD, and send the composited image to the HMD so the user can see the combined image.

3. The system of claim 1 wherein the keying module is configured to take in a live action image from the camera, and perform a color difference and despill operation on the image to determine how to mix it with an image of a virtual environment.

4. The system of claim 1 wherein the camera is mounted to the front of the HMD and facing forward, to provide a view of the real environment in the direction that the user is looking.

5. The system of claim 1 further comprising an upward-facing tracking sensor configured to be carried by the user of the HMD and to detect overhead tracking markers.

6. The system of claim 5 wherein the sensor is configured to determine a position of the user in a physical space, and the keying module is configured to determine which areas of the physical space will be visually replaced by virtual elements.

7. The system of claim 1 wherein the virtual elements will be visually replaced when areas of the live action environment are painted a solid blue or green color.

8. The system of claim 1 wherein the sensor is configured to calculate the position of the HMD in a physical environment, and that information is used to render a virtual image from the correct point of view that is mixed with the live action view and displayed in the HMD.

9. The system of claim 1 wherein each user of the HMD has a separate tracking sensor and rendering computer, whose function is independent of the sensors and rendering computers of the other users.

10. The system of claim 9 wherein a tracking system of the sensor is not dependent on the other users because it can calculate the complete position and orientation of the HMD based upon the view of the overhead markers without communicating with any external sensors.

11. The system of claim 1 wherein the front facing camera or cameras are configured to provide a real time view of the environment that the user is facing.

12. The system of claim 1 wherein the low latency is on the order of 25 milliseconds.

13. The system of claim 1 wherein the sensor is a self-contained 6DOF tracking sensor.

14. The system of claim 1 wherein the keying module is configured to allow an environment designer to determine which components of an environment of the user are to be optically passed through and which are to be replaced by virtual elements.

15. The system of claim 1 wherein the keying module is configured to handle transitions between virtual and real worlds in a game or simulation by reading the image from the front facing camera, performing a color difference key process on the image to remove the solid blue or green elements from the image, and then combining this image with a virtual rendered image.

16. The system of claim 1 wherein the keying module is embodied in low latency programmable hardware.

17. The system of claim 1 wherein the keying module is configured to calculate the color difference between the red, green and blue elements of a region of a live action image, to use that difference to determine the portions of the live action image to remove, and use a despill calculation to limit the amount of blue or green in the image and remove colored fringes from the image.

18. The system of claim 1 wherein the number of users of the self-contained tracking system can be greater than five because the tracking system can calculate its position based on a view of overhead markers without needing to communicate with an external tracking computer.

19. The system of claim 1 wherein the users of the self-contained tracking system can be located very close to each other without experiencing tracking problems, as the tracking system can calculate its position even when occluded to either side.

20. The system of claim 1 wherein the users of the self-contained tracking system can walk very close to head height walls without experiencing tracking problems, as the tracking system can calculate its position even when occluded to either side.

21-52. (canceled)
